(19) United States
(12) Patent Application Publication
(10) Pub. No.: US 2009/0128757 A1
(43) Pub. Date: May 21, 2009

(54) LIQUID CRYSTAL DEVICE AND ELECTRONIC APPARATUS

(75) Inventors: Takeshi KOSHIHARA, Suwa-shi (JP); Hiroyuki ABE, Matsumoto-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: SEIKO EPSON CORPORATION, Tokyo (JP)

(21) Appl. No.: 12/248,216

(22) Filed: Oct. 9, 2008

(30) Foreign Application Priority Data
Nov. 19, 2007 (JP) 2007-298922

(51) Int. Cl. G02F 1/1335

(52) U.S. Cl. 349/114

(57) ABSTRACT

A transflective or reflective liquid crystal device includes an element substrate, an opposite substrate, and a liquid crystal layer. A translucent pixel electrode that is electrically connected to a pixel switching element in each of a plurality of pixels and a translucent common electrode that forms a fringe electric field between the pixel electrode and the common electrode are formed so as to overlap each other via a first dielectric layer in plan view in the element substrate. The opposite substrate is arranged so as to face the element substrate. The liquid crystal layer is held between the opposite substrate and the element substrate. A light reflection layer is formed on the element substrate so as to overlap the pixel electrode(s) and the common electrode in plan view in a lower layer below the pixel electrode(s) and the common electrode. The light reflection layer is formed so as to overlap one electrode, which is located on a lower layer side, between the pixel electrode(s) and the common electrode via a second dielectric layer in plan view, and is applied with the same electric potential as that of the other electrode located on an upper layer side. In each of the plurality of pixels, a holding capacitor is formed of a capacitance component formed between the pixel electrode and the common electrode and a capacitance component formed between the one electrode and the light reflection layer.

### BACKGROUND

1. Technical Field

The present invention relates to a so-called fringe field switching (FFS) mode liquid crystal device and an electronic apparatus that includes the liquid crystal device.

2. Related Art

In a liquid crystal device used in a cellular phone or a mobile computer, to achieve a wide viewing angle, an FFS mode liquid crystal device that drives a liquid crystal using a horizontal electric field is been practically used (see JP-A-2002-182230).

The above liquid crystal device, as shown in FIG. 10A and FIG. 10B, includes, for example, an element substrate 10, an opposite substrate 20, and a liquid crystal layer 50. The element substrate 10 is formed by laminating transparent pixel electrodes 7a and a transparent common electrode 9a via an insulating film 74 in plan view. Each transparent pixel electrode 7a is electrically connected to a thin film transistor 30, which serves as a pixel switching element, in each of a plurality of pixels 100a. The opposite substrate 20 is arranged to face the element substrate 10. The liquid crystal layer 50 is held between the opposite substrate 20 and the element substrate 10. Between the pixel electrodes 7a and the common electrode 9a, the pixel electrodes 7a formed on the upper layer side have slits 7b to form a fringe electric field between the pixel electrodes 7a and the common electrode 9a. In the liquid crystal device 100, a capacitance component C1 developed at a portion at which each pixel electrode 7a overlaps the common electrode 9a is used as a holding capacitor 60. In addition, in the liquid crystal device 100, when display is performed in a reflection mode in which light that enters from the side of the opposite substrate 20 exits from the opposite substrate 20 again, a light reflection layer 8s is formed in a lower layer below the common electrode 9a, and the light reflection layer 8a is placed in an electrically floating state.

However, in the FFS mode liquid crystal device 100, the width of each slit 7b of each pixel electrode 7a and the thickness of the insulating film 74 are set in consideration of driving characteristics for the liquid crystal layer 50. Thus, the area of a portion at which each pixel electrode 7a overlaps the common electrode 9a may be small and therefore the capacitance C1 may be excessively small. This may cause insufficient operation of the holding capacitor 60. In this case, as in the case of a TN (Twisted Nematic) mode liquid crystal device, it is conceivable that a capacitor line is formed to form a holding capacitor; however, if a holding capacitor that uses a capacitor line is formed in the FFS mode liquid crystal device 100, it impairs the advantages of the FFS mode liquid crystal device.

### SUMMARY

An advantage of some aspects of the invention is that it provides a transflective or reflective liquid crystal device that is able to form a holding capacitor having a sufficient capacitance and also provides an electronic apparatus that includes the liquid crystal device.

An aspect of the invention provides a transflective or reflective liquid crystal device. The liquid crystal device includes an element substrate, an opposite substrate, and a liquid crystal layer. A translucent pixel electrode that is electrically connected to a pixel switching element in each of a plurality of pixels and a translucent common electrode that forms a fringe electric field between the pixel electrode and the common electrode are formed so as to overlap each other via a first dielectric layer in plan view in the element substrate. The opposite substrate is arranged so as to face the element substrate. The liquid crystal layer is held between the opposite substrate and the element substrate. A light reflection layer is formed on the element substrate so as to overlap the pixel electrode(s) and the common electrode in plan view in a lower layer below the pixel electrode(s) and the common electrode. The light reflection layer is formed so as to overlap one electrode, which is located on a lower layer side, between the pixel electrode(s) and the common electrode via a second dielectric layer in plan view, and is applied with the same electric potential as that of the other electrode located on an upper layer side. In each of the plurality of pixels, a holding capacitor is formed of a capacitance component formed between the pixel electrode and the common electrode and a capacitance component formed between the one electrode and the light reflection layer.

In the transflective or reflective FFS mode liquid crystal device according to the aspect of the invention, because the light reflection layer, formed of a metal film, that enables display in a reflection mode is arranged so as to overlap one electrode, which is located in a lower layer side, between the pixel electrode and the common electrode via a second dielectric layer in plan view, and is applied with the same electric potential as that of the other electrode located on an upper layer side, a capacitance component formed between the one electrode and the light reflection layer forms a holding capacitor with a capacitance component formed between the pixel electrode and the common electrode. Thus, even when the shape of each pixel electrode or the thickness of the first dielectric layer is set in consideration of driving characteristics for the liquid crystal layer and therefore the capacitance component developed at a portion at which the pixel electrode overlaps the common electrode is excessively small, the capacitance component formed between the one electrode and the light reflection layer is able to compensate for the shortage of the capacitance value. Hence, in the transflective or reflective liquid crystal device, without adding a capacitor line, it is possible to form a holding capacitor having a sufficient capacitance.

In the aspect of the invention, it is possible to employ a configuration that the one electrode is the common electrode and the other electrode is the pixel electrode. In this case, the light reflection layer may be separately formed in each of the plurality of pixels. When the above configuration is employed, each light reflection layer may be electrically connected to the pixel switching element, and each pixel electrode may be electrically connected to the pixel switching element through the light reflection layer. With the above configuration, the same signal may be applied to both the pixel electrode and the light reflection layer, and the pixel electrode and the pixel switching element may be electrically connected with a simple structure.

In the aspect of the invention, it is possible to employ a configuration that the one electrode is the pixel electrode and the other electrode is the common electrode. In this case, each light reflection layer may be formed to extend over the plurality of pixels, and the common electrode may be connected to the light reflection layer at multiple portions. With the above configuration, even when a resistance value is high due to the common electrode being formed of a thin translucent conductive film, the light reflection layer functions as an auxiliary wiring. Thus, it is possible to obtain the similar advantageous effect to that the resistance value of the common electrode is reduced. In the aspect of the invention, it is possible to employ a configuration that the light reflection layer extends in a band shape over the plurality of pixels. With the above configuration, in either cases when the liquid crystal device is of a transflective type or when the liquid crystal device is of a reflective type, it is possible to use the light reflection layer as an auxiliary wiring for the common electrode. Thus, it is possible to obtain the similar advantageous effect to that the resistance value of the common electrode is reduced.

The liquid crystal device according to the aspects of the invention may be used as a display portion of an electronic apparatus, such as a cellular phone or a mobile computer.

### BRIEF DESCRIPTION OF THE DRAWINGS

The invention will be described with reference to the accompanying drawings, wherein like numbers reference like elements.

FIG. 1A is a plan view of a liquid crystal device according to the aspects of the invention together with components formed thereon as viewed from the side of an opposite substrate.

FIG. 1B is a cross-sectional view that is taken along the line IB-IB in FIG. 1A.

FIG. 2 is an equivalent circuit diagram that shows an electrical configuration of an image display area of an element substrate used in the liquid crystal device according to the aspects of the invention.

FIG. 3A is a cross-sectional view of a pixel of the liquid crystal device according to a first embodiment of the invention, taken along the line IIIA-IIIA in FIG. 3B.

FIG. 3B is a plan view of mutually adjacent pixels in the element substrate.

FIG. 4A to FIG. 4E are cross-sectional views showing processes of a manufacturing method for the element substrate used in the liquid crystal device according to the first embodiment of the invention.

FIG. 5A is a cross-sectional view of a pixel of a liquid crystal device according to a second embodiment of the invention, taken along the line VA-VA in FIG. 5B.

FIG. 5B is a plan view of mutually adjacent pixels in the element substrate.

FIG. 6A is a cross-sectional view of a pixel of a liquid crystal device according to a third embodiment of the invention, taken along the line VIA-VIA in FIG. 6B.

FIG. 6B is a plan view of mutually adjacent pixels in the element substrate.

FIG. 7A to FIG. 7E are cross-sectional views showing processes of a manufacturing method for the element substrate used in the liquid crystal device according to the third embodiment of the invention.

FIG. 8A is a cross-sectional view of a pixel of the liquid crystal device according to a fourth embodiment of the invention, taken along the line VIIIA-VIIIA in FIG. 8B.

FIG. 8B is a plan view of mutually adjacent pixels in the element substrate.

FIG. 9A to FIG. 9C are views that illustrate electronic apparatuses that use the liquid crystal device according to the aspects of the invention.

FIG. 10A is a cross-sectional view of a pixel of an existing liquid crystal device.

FIG. 10B is a plan view of mutually adjacent pixels in the element substrate.

### DESCRIPTION OF EXEMPLARY EMBODIMENTS

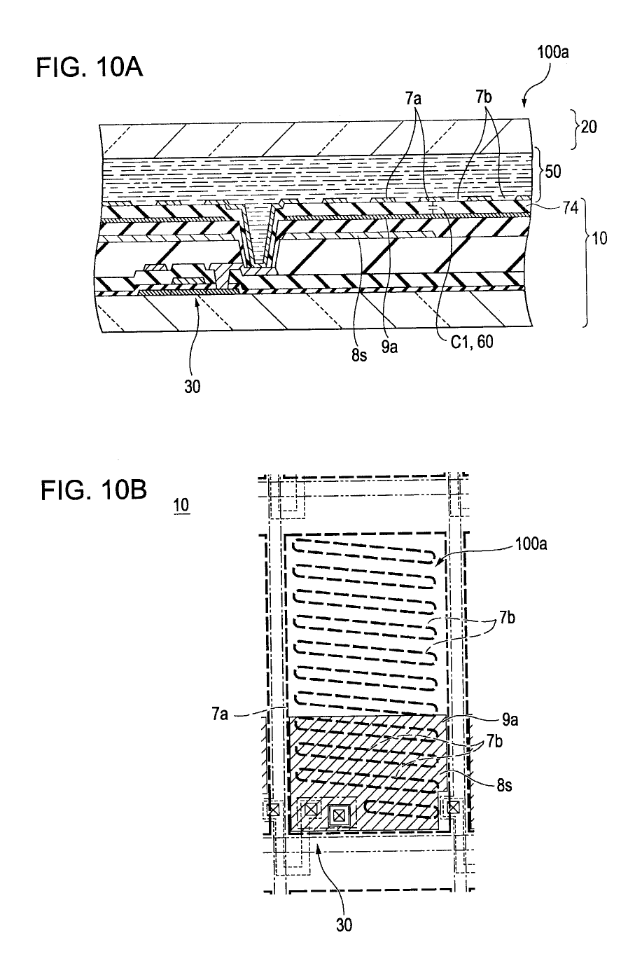

Hereinafter, embodiments of the invention will be described. In addition, in the drawings referred in the following description, to make it easier to recognize layers and components shown in the drawings, the scale is varied for each of the layers and components. In addition, in a thin film transistor, a source and a drain are changed depending on a voltage applied; however, in the following description, for easier description, the one to which a pixel electrode is connected is described as a drain. Furthermore, in the following description, for easily recognizing the correspondence between the configurations of embodiments and the configuration described with reference to FIG. 10A and FIG. 10B, the common components will be described by assigning the same reference numerals as much as possible.

### First Embodiment

### General Configuration

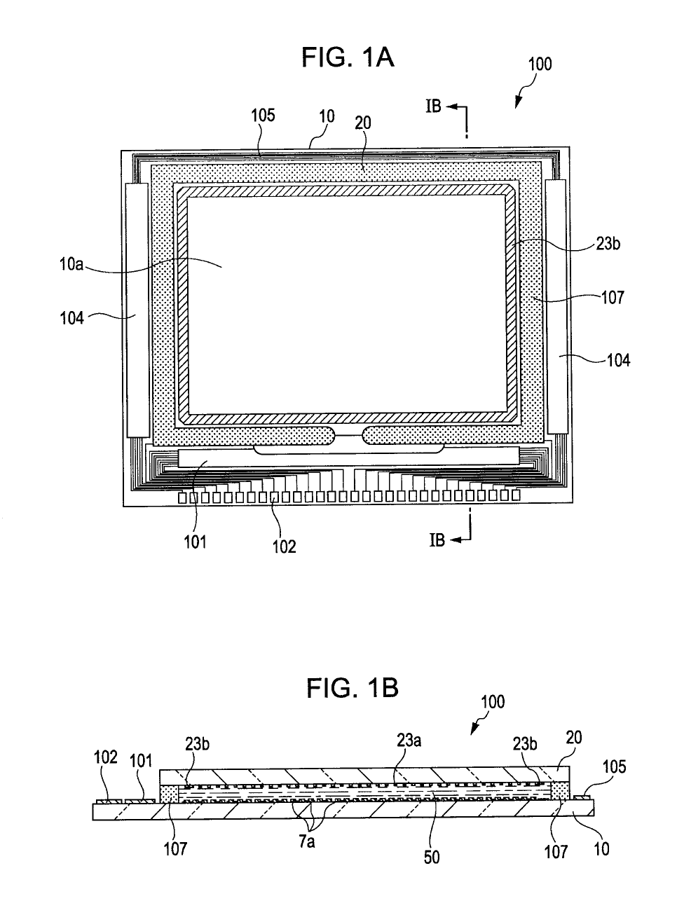

FIG. 1A is a plan view of a liquid crystal device according to the aspects of the invention together with components formed thereon as viewed from the side of an opposite substrate. FIG. 1B is a cross-sectional view that is taken along the line IB-IB in FIG. 1A.

As shown in FIG. 1A and FIG. 1B, a liquid crystal device 100 of the present embodiment is a transflective active matrix liquid crystal device, and includes an element substrate 10 and an opposite substrate 20, which are adhered to each other by a seal material 107 with a predetermined gap. The opposite substrate 20 has substantially the same outline as that of the seal material 107. A liquid crystal layer 50 is held between the element substrate 10 and the opposite substrate 20. The liquid crystal layer 50 is homogeneously aligned in an area defined by the seal material 107. The liquid crystal layer 50 is a liquid crystal composite of which the dielectric constant in the alignment direction has a positive anisotropy of dielectric constant larger than that in the normal direction and gives a nematic phase in a wide temperature range.

In the element substrate 10, a data line driving circuit 101 and mounted terminals 102 are provided in an area outside of the seal material 107 along one side of the element substrate 10, and a scanning line driving circuit 104 is formed along two sides that are adjacent to the side at which the mounted terminals 102 are arranged. A plurality of wirings 105 that connect the scanning line driving circuits 104 provided on both sides of the image display area 10a are provided at the remaining one side of the element substrate 10. Furthermore, a peripheral circuit, such as a pre-charge circuit or a detection circuit, may be provided on the lower side of a window frame 23b or the like.

Although it will be described in detail later, pixel electrodes 7a are formed on the element substrate 10 in a matrix. In contrast, the window frame 23b, which is formed of a light shielding material, is formed in an area inside the seal material 107 on the opposite substrate 20, and the inside of the window frame 23b forms an image display area 10a. In the opposite substrate 20, a light shielding film 23a, which is called a black matrix or a black stripe, is formed in an area opposite the vertical and horizontal boundary areas of the pixel electrodes 7a of the element substrate 10.

The liquid crystal device 100 according to the present embodiment drives the liquid crystal layer 50 in an FFS mode. Therefore, in the element substrate 10, a common electrode (not shown in FIG. 1B) is formed in addition to the pixel electrodes 7a, and no opposite electrode is formed in the opposite substrate 20. For this reason, because static electricity easily enters from the side of the opposite substrate 20, a shielding layer formed of an ITO (indium tin oxide) film may possibly be formed on a face of the opposite substrate 20 on a side opposite to the side of the element substrate 10.

Because the liquid crystal device 100 of the present embodiment is of a transflective type, the opposite substrate 20 is arranged on a side through which display light exits, and a backlight device (not shown) is arranged on a side opposite to the opposite substrate 20 with respect to the element substrate 10. In addition, an optical member (not shown) such as a polarizer is arranged on each of the opposite substrate 20 and the element substrate 10. Note that the liquid crystal device 100 may be configured as a reflective type, and in this case, the backlight device and the optical member on the side of the element substrate 10 are omitted.

### Detailed Configuration of Liquid Crystal Device 100

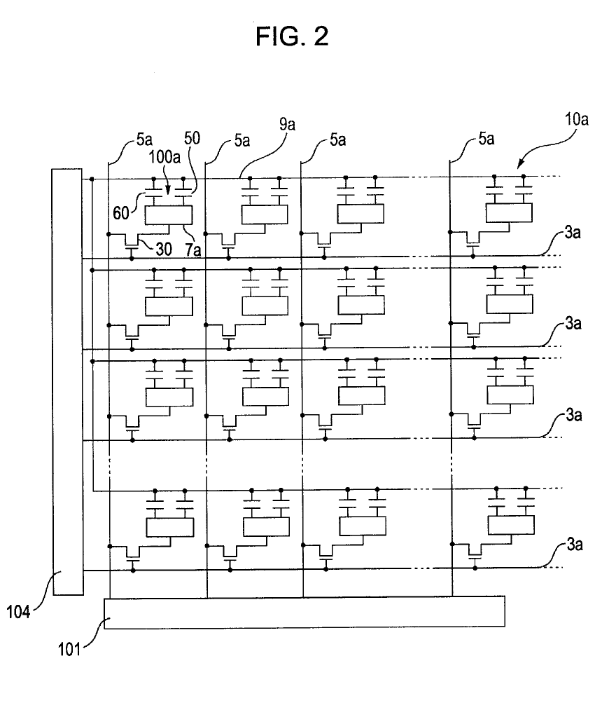

The liquid crystal device 100 according to the aspects of the invention and the configuration of the element substrate 10 used therein will be described with reference to FIG. 2. FIG. 2 is an equivalent circuit diagram that shows an electrical configuration of the image display area 10a of the element substrate 10 used in the liquid crystal device 100 according to the aspects of the invention.

As shown in FIG. 2, a plurality of pixels 100a are formed in a matrix in the image display area 10a of the liquid crystal device 100. Each of the plurality of pixels 100a includes a pixel electrode 7a and a thin film transistor 30 (pixel transistor) for controlling the pixel electrode 7a. Data lines 5a, which supply data signals (image signals) in line sequential, are electrically connected to the sources of the corresponding thin film transistors 30. Scanning lines 3a are electrically connected to the gates of the corresponding thin film transistors 30. The scanning lines 3a are configured to be applied with scanning signals at a predetermined timing in line sequential. Each of the pixel electrodes 7a is electrically connected to the drain of the corresponding thin film transistor 30. Each pixel electrode 7a writes a data signal, which is supplied from the data line 5a, into the corresponding pixel 100a at a predetermined timing in such a manner that the thin film transistor 30 is placed in an on state only during a certain period. In this manner, a pixel signal of a predetermined level, written into the liquid crystal layer 50 through the pixel electrode 7a, is held between the pixel electrode 7a and the common electrode 9a, which are formed in the element substrate 10, during a certain period.

Here, a holding capacitor 60 is formed between each pixel electrode 7a and the common electrode 9a owing to a capacitance component which will be described later, and the voltage of the pixel electrode 7a is, for example, held during a period of time three digits longer than a period of time during which a source voltage is being applied. Thus, the charge holding characteristic is improved, and it is possible to achieve the liquid crystal device 100 that is able to perform high-contrast display.

In FIG. 2, the common electrode 9a is shown as a wiring extending from the scanning line driving circuit 104; however, as will be described later, the common electrode 9a is formed on the entire surface of the image display area 10a of the element substrate 10 and is held at a predetermined electric potential. In addition, the common electrode 9a may be formed to extend over the plurality of pixels 100a or may be formed for each of the plurality of pixels 100a; however, in either cases, a constant electric potential is applied.

### Detailed Configuration of Each Pixel

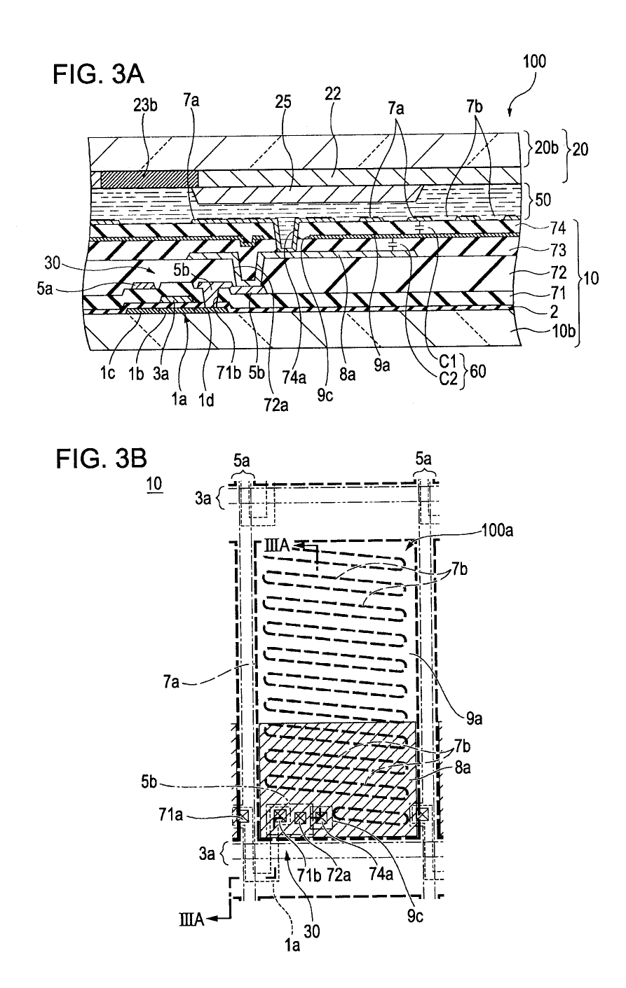

FIG. 3A is a cross-sectional view of a pixel of the liquid crystal device 100 according to the first embodiment of the invention. FIG. 3B is a plan view of mutually adjacent pixels in the element substrate 10. FIG. 3A corresponds to a cross-sectional view of the liquid crystal device 100, taken along the line IIIA-IIIA in FIG. 3B. On the other hand, in FIG. 3B, the pixel electrodes 7a are indicated by a long dotted line, the data lines 5a and the thin films, which are formed at the same time with the data lines 5a, are indicated by alternate long and short dash line, and the scanning lines 3a are indicated by alternate long and two short dashes line. In addition, in FIG. 3B, light reflection layers are indicated as areas by positive oblique lines.

As shown in FIG. 3A and FIG. 3B, on the element substrate 10, the transparent pixel electrodes 7a (areas surrounded by long dotted line) are formed at positions corresponding to the pixels 100a, and the data lines 5a (areas indicated by alternate long and short dash line) and the scanning lines 3a (areas indicated by alternate long and two short dashes line) extend along the vertical and horizontal boundary areas between the adjacent pixel electrodes 7a. In addition, in the element substrate 10, the transparent common electrode 9a is formed over substantially the entire surface of the image display area 10a shown in FIG. 2A. The pixel electrodes 7a and the common electrode 9a both are formed of an ITO film.

In the present embodiment, between the pixel electrodes 7a and the common electrode 9a, the common electrode 9a is formed as one electrode located on the lower layer side and each pixel electrode 7a is formed as the other electrode located on the upper layer side. Thus, in the present embodiment, a plurality of slits 7b for forming an fringe electric field are formed parallel to one another in each of the upper side pixel electrodes 7a, and the slits 7b extend, for example, at an angle of 5 degrees with respect to the scanning lines 3a.

The base body of the element substrate 10 shown in FIG. 3A is formed of a translucent substrate 10b, such as a quartz substrate or a heat resistant glass substrate. The base body of the opposite substrate 20 shown in FIG. 3A is formed of a translucent substrate 20b, such as a quartz substrate or a heat resistant glass substrate. In the present embodiment, both of the translucent substrates 10b and 20b are formed of a glass substrate. In the element substrate 10, a base protection film (not shown), which is formed of a silicon oxide film, or the like, is formed on the front surface of the translucent substrate 10b, and, on the front surface side, a top gate type thin film transistor 30 is formed at a position corresponding to each of the pixel electrodes 7a.

As shown in FIG. 3A and FIG. 3B, each of the thin film transistors 30 has a structure such that a channel region 1b, a source region 1c and a drain region 1d are formed in an island-like semiconductor layer 1a. The thin film transistor 30 may be formed so as to have an LDD (Lightly Doped Drain) structure in which a lightly doped region is provided on each side of the channel region 1b. In the present embodiment, the semiconductor layer 1a is a polysilicon film such that an amorphous silicon film is formed on the element substrate 10 and then polycrystallized by laser annealing, lamp annealing, or the like. A gate insulating film 2, which is formed of a silicon oxide film, silicon nitride film, or a laminated film of them, is formed in the upper layer on the semiconductor layer 1a, and part of the scanning line 3a overlaps in the upper layer on the gate insulating film 2 as a gate electrode. In the present embodiment, each semiconductor layer 1a is bent into a U shape and has a twin gate structure in which a gate electrode is formed at two portions in a channel direction of the semiconductor layer 1a.

An interlayer insulating film 71, which is formed of a silicon oxide film, silicon nitride film, or a laminated film of them, is formed in the upper layer on the gate electrodes (scanning lines 3a). The data lines 5a are formed on the surface of the interlayer insulating film 71. Each data line 5a is electrically connected through a contact hole 71a, which is formed in the interlayer insulating film 71 and the gate insulating film 2, to a source region located at a position closest to the data line 5a. Moreover, drain electrodes 5b are formed on the surface of the interlayer insulating film 71. Each drain electrode 5b is a conductive film that is formed at the same time with the data lines 5a. An interlayer insulating film 72 and insulating films 73 and 74 are formed in the upper layer on the data lines 5a and on the drain electrodes 5b. In the present embodiment, the insulating film 74 may be regarded as a first dielectric layer, and the insulating film 73 may be regarded as a second dielectric layer.

Light reflection layers 8a, which are formed of an aluminum film, an aluminum alloy film, a silver film or a silver alloy film, are formed on the surface of the interlayer insulating film 72. The common electrode 9a, which is formed of a solid ITO film, is formed on the surface of the insulating film 73, which serves as a second dielectric layer. The pixel electrodes 7a are formed in an island shape in the upper layer on the insulating film 74, which serves as a first dielectric layer, and slits 7b are formed in each of the pixel electrodes 7a.

On the inner surface (a face on a side on which the liquid crystal layer 50 is provided) of the opposite substrate 20, a light shielding film 23a, which is called a black matrix or the like, is formed in areas that overlap the boundary regions between the adjacent pixel electrodes 7a, and color filters 22 corresponding to respective colors are formed in areas surrounded by the light shielding film 23.

Though not shown in the drawing, alignment layers are respectively formed on the element substrate 10 and the opposite substrate 20. A rubbing process is performed on the alignment layer on the side of the opposite substrate 20 in a direction parallel to the scanning lines 3a, and a rubbing process is performed on the alignment layer on the side of the element substrate 10 in a direction opposite to the rubbing direction in which the rubbing process is performed on the alignment layer of the opposite substrate 20. Thus, the liquid crystal layer 50 may be placed in a homogeneous alignment. Here, the slits 7b formed in each of the pixel electrodes 7a of the element substrate 10 are formed parallel to one another, and extend at an angle of 5 degrees with respect to the scanning lines 3a. Thus, for the alignment layers, a rubbing process is performed in a direction at an angle of 5 degrees with respect to the direction in which the slits 7b extend. In addition, polarizers are arranged so that their polarization axes are perpendicular to each other, the polarization axis of the polarizer on the side of the opposite substrate 20 is perpendicular to the rubbing direction of the alignment layer, and the polarization axis of the polarizer on the side of the element substrate 10 is parallel to the rubbing direction of the alignment layer.

In the thus configured transflective liquid crystal device 100, the light reflection layer 8a is formed only in a portion of an area that overlaps the common electrode 9a and the pixel electrode 7a in each of the plurality of pixels 100a. Thus, it is possible to display an image in a reflection mode in such a manner that light that enters from the side of the opposite substrate 20 is reflected on the light reflection layer 8a and then exits from the side of the opposite substrate 20, while it is possible to display an image in a transmission mode in such a manner that light that exits from the backlight device enters from the side of the element substrate 10, penetrates through an area (transmission display area) in which no light reflection layer 8a is formed and then exits from the side of the opposite substrate 20. Thus, the length of a path along which light travels is different between the transmission mode and the reflection mode. Then, in the present embodiment, on an inner face of the opposite substrate 20, a retardation layer 25 formed of liquid crystal polymer is formed in an area (reflection display area) that overlaps the light reflection layer 8a. Thus, even when the length of a path along which light travels is different between the transmission mode and the reflection mode, it is possible to adjust both retardations.

### Configuration of Holding Capacitor 60

The insulating films 73 and 74 may be formed of a silicon oxide film, a silicon nitride film, or a laminated film of them. In the present embodiment, the insulating films 73 and 74 both are formed of a silicon nitride film having a dielectric constant higher than a silicon oxide film, and have a thickness of 100 to 300 nm. Therefore, both the insulating films 73 and 74 are able to sufficiently function as a dielectric layer. In addition, as a silicon nitride film is used for the insulating films 73 and 74, because the silicon nitride film has a high refractive index, it is possible to suppress unnecessary reflection at the interface with the ITO film. Note that the interlayer insulating film 72 is formed as a planarizing film formed of a thick photosensitive resin having a thickness of 1.5 to 2.0 μm.

The light reflection layer 8a is formed separately in an island shape in each of the plurality of pixels 100a, and is electrically connected to the drain electrode 5b through a contact hole 72a formed in the interlayer insulating film 72. The drain electrode 5b is electrically connected to the drain region 1d of the thin film transistor 30 through a contact hole 71b formed in the interlayer insulating film 71 and the gate insulating film 2. The pixel electrode 7a is electrically connected to the light reflection layer 8a through a contact hole 74a formed in the insulating films 73 and 74. Thus, the light reflection layer 8a is electrically connected to the thin film transistor 30 through the drain electrode 5b, and the pixel electrode 7a is electrically connected to the thin film transistor 30 through the light reflection layer 8a and the drain electrode 5b. For this reason, the light reflection layer 8a is applied with the same signal (electric potential) as that of the pixel electrode 7a. Note that in order to allow electrical connection between the pixel electrode 7a and the light reflection layer 8a, the common electrode 9a has a cutout 9c.

In the thus configured liquid crystal device 100, a capacitance component C1 is formed at a portion at which the pixel electrode 7a overlaps the common electrode 9a via the insulating film 74 (first dielectric layer), while a capacitance component C2 is formed at a portion at which the common electrode 9a overlaps the light reflection layer 8a via the insulating film 73 (second dielectric layer). Furthermore, the capacitance component C1 and the capacitance component C2 are electrically connected in parallel with each other. Thus, in the present embodiment, the holding capacitor 60 is formed of a composite capacitance component of the capacitance components C1 and C2.

### Manufacturing Method

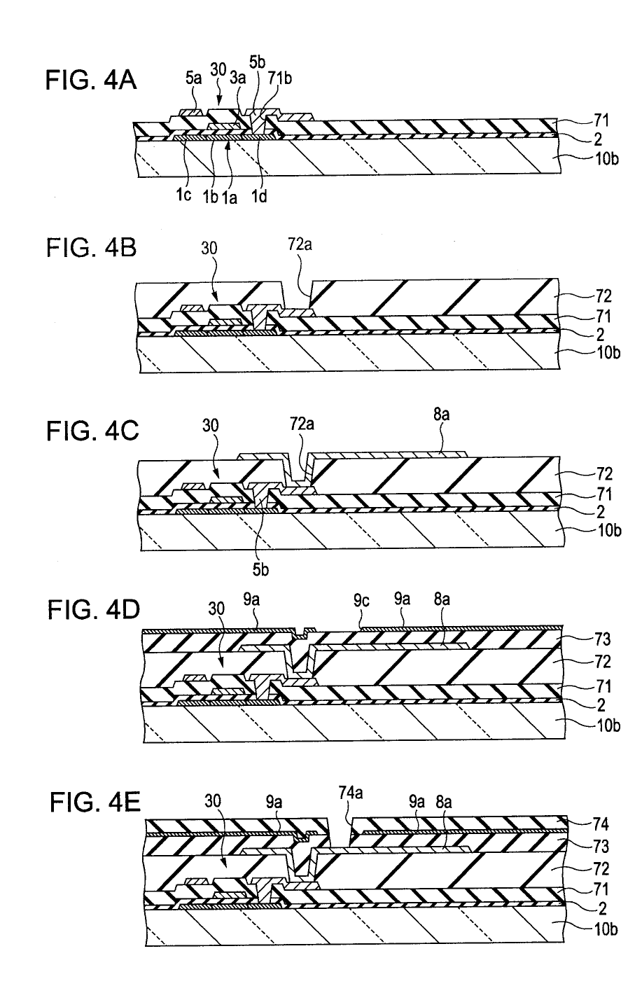

FIG. 4A to FIG. 4E are cross-sectional views showing processes of a manufacturing method for the element substrate within a manufacturing process for the liquid crystal device according to the first embodiment of the invention. To manufacture the element substrate 10 used in the liquid crystal device 100 of the present embodiment, first, as shown in FIG. 4A, a base protection film (not shown) formed of a silicon oxide film is formed on the surface of the translucent substrate 10b formed of a glass substrate and then a thin film transistor forming process is performed. Specifically, first, the semiconductor layers 1a formed of a polysilicon film are formed in an island shape. To do so, under temperature conditions that the temperature of the substrate is 150 to 450 degrees C., a semiconductor layer formed of an amorphous silicon film having, for example, a thickness of 40 to 50 nm is formed over the entire surface of the translucent substrate 10b by means of a plasma CVD method and then the silicon film is polycrystallized through laser annealing, or the like. After that, the polycrystallized silicon film is patterned using a photolithography technology to form the semiconductor layers 1a. Subsequently, using a CVD method, or the like, the gate insulating film 2 formed of a silicon nitride film, a silicon oxide film or a laminated film of them is formed on the surface of the semiconductor layers 1a. Then, a metal film such as a molybdenum film, an aluminum film, a titanium film, a tungsten film or a tantalum film is formed over the entire surface of the translucent substrate 10b and then patterned using a photolithography technology to form the scanning lines 3a (gate electrodes). Next, impurities are implanted into the semiconductor layers 1a to form the source regions 1c, drain regions 1d and channel regions 1b of the thin film transistors 30.

Next, in a first interlayer insulating film forming process, using a CVD method or the like, the interlayer insulating film 71 formed of a silicon nitride film, a silicon oxide film or a laminated film of them is formed. Subsequently, using a photolithography technology, contact holes 71a (not shown) and 71b are formed in the interlayer insulating film 71. After that, in a data line forming process, a metal film such as a molybdenum film, an aluminum film, a titanium film, a tungsten film, a tantalum film or a laminated film of them is formed over the entire surface of the translucent substrate 10b and then patterned using a photolithography technology to form the data lines 5a and the drain electrodes 5b. As a result, as shown in FIG. 3B, the data lines 5a are electrically connected to the source regions of the thin film transistors 30 through the contact holes 71a, and the drain electrodes 5b are electrically connected to the drain regions 1d of the thin film transistors 30 through the contact holes 71b.

Next, in a second interlayer insulating film forming process, a photosensitive resin is applied, exposed and developed and then, as shown in FIG. 4B, the interlayer insulating film 72 (planarizing film) that has the contact holes 72a are formed to have a thickness of 1.5 to 2.0 μm.

Subsequently, in a light reflection layer forming process, as shown in FIG. 4C, a light reflective metal film formed of aluminum, aluminum alloy, silver or silver alloy is formed over the entire surface of the translucent substrate 10b, the metal film is patterned using a photolithography technology, and then the light reflection layer 8a is formed in an island shape in each of the plurality of pixels 100a. As a result, each light reflection layer 8a is electrically connected to the drain electrode 5b through the contact hole 72a.

Then, in a lower layer insulating film forming process, as shown in FIG. 4D, using a CVD method or the like, the insulating film 73 formed of a silicon nitride film is formed.

Next, in a common electrode forming process, a translucent conductive film formed of an ITO film is formed over the entire surface of the translucent substrate 10b, and the translucent conductive film is patterned using a photolithography technology to form the common electrode 9a. At this time, the cutouts 9c are formed in the common electrode 9a.

After that, in an upper layer insulating film forming process, as shown in FIG. 4E, using a CVD method or the like, the insulating film 74 formed of a silicon nitride film is formed, and then using a photolithography technology, the contact holes 74a are formed in the insulating films 73 and 74. Note that when the contact holes 74a are formed, contact holes that are in communication with each other may be formed respectively in the insulating films 73 and 74 through different processes.

Next, in a pixel electrode forming process, a translucent conductive film formed of an ITO film is formed over the entire surface of the translucent substrate 10b, and the translucent conductive film is patterned using a photolithography technology to form the pixel electrodes 7a each having the slits 7b, as shown in FIG. 3A and FIG. 3B. As a result, each pixel electrode 7a is electrically connected to the light reflection layer 8a through the contact hole 74a.

### Major Advantageous Effects of Present Embodiment

As described above, the liquid crystal device 100 of the present embodiment employs an FFS mode, each of the upper side pixel electrodes 7a has the plurality of slits 7b for forming a fringe electric field, and the lower side common electrode 9a is arranged in a region that overlaps the plurality of slits 7b. Thus, it is possible to drive the liquid crystal layer 50 using a fringe electric field formed between the upper side pixel electrodes 7a and the lower side common electrode 9a.

In addition, the capacitance component C1 formed at a portion at which the upper side pixel electrode 7a faces the lower side common electrode 9a via the insulating film 74 (first dielectric layer) may be used as a portion of the holding capacitor 60.

Furthermore, in the liquid crystal device 100 of the present embodiment, the light reflection layer 8a formed of a metal film is arranged so as to overlap the common electrode 9a located in the lower layer side via the insulating layer 73 (second dielectric layer) in plan view, and is applied with the same electric potential as that of the pixel electrode 7a located in the upper layer side. Thus, the capacitance component C2 formed between the light reflection layer 8a and the common electrode 9a forms the holding capacitor 60 together with the capacitance component C1 formed between the pixel electrode 7a and the common electrode 9a. Thus, even when the width of each slit of each pixel electrode 7a or the thickness of the insulating film 74 is set in consideration of driving characteristics for the liquid crystal layer 50 and therefore the capacitance component C1 developed at a portion at which the pixel electrode 7a overlaps the common electrode 9a is excessively small, the capacitance component C2 formed between the light reflection layer 8a and the common electrode 9a is able to compensate for the shortage of the capacitance value. Hence, in the transflective liquid crystal device 100, without adding a capacitor line, it is possible to form the holding capacitor 60 having a sufficient capacitance.

### Second Embodiment

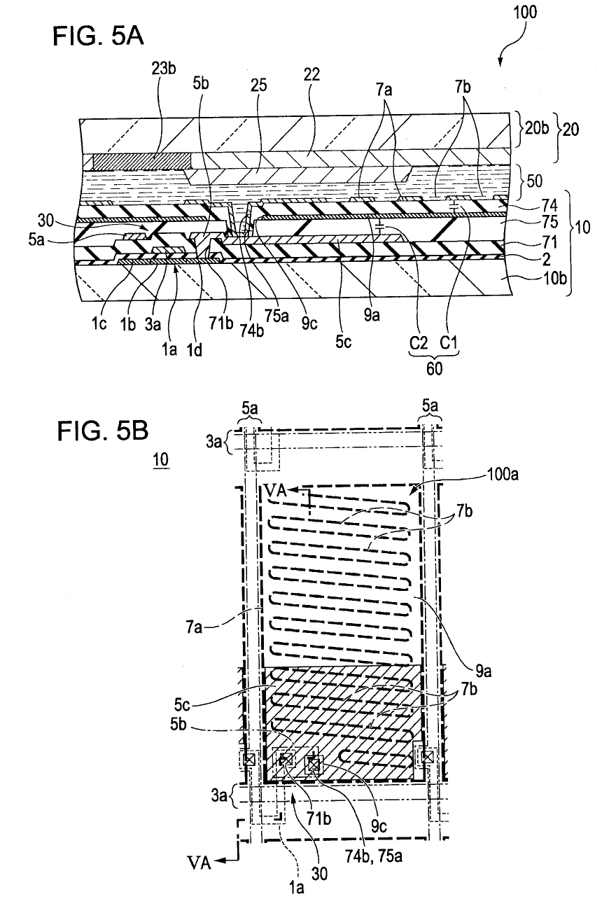

FIG. 5A is a cross-sectional view of a pixel of a liquid crystal device 100 according to a second embodiment of the invention. FIG. 5B is a plan view of mutually adjacent pixels in the element substrate 10. FIG. 5A corresponds to a cross-sectional view of the liquid crystal device 100, taken along the line VA-VA in FIG. 5B. Note that the basic configuration of the present embodiment is the same as that of the first embodiment, so that the same reference numerals are assigned to the same or similar components, and a description thereof is omitted.

The liquid crystal device 100 shown in FIG. 5A and FIG. 5B is also a transflective liquid crystal device as in the case of the first embodiment. In the element substrate 10, the drain electrodes 5b formed in an upper layer on the interlayer insulating film 71 are electrically connected to the drain regions 1d of the thin film transistors 30 through the contact holes 71b formed in the interlayer insulating film 71.

In the present embodiment, each drain electrode 5b is extended to an area that overlaps the common electrode 9a and the pixel electrode 7a on the lower layer side, and the extended portion 5c of the drain electrode 5b is used as a light reflection layer for displaying an image in a reflection mode. Thus, each drain electrode 5b has a structure such that a light reflective metal film is entirely made of aluminum, aluminum alloy, silver, or silver alloy or a light reflective metal film made of aluminum, aluminum alloy, silver or silver alloy is laminated in an upper layer on a metal film such as a molybdenum film, a titanium film, a tungsten film, or a tantalum film.

In addition, an insulating film 75 (second dielectric layer) formed of a silicon oxide film, a silicon nitride film, a laminated film of them or a thin photosensitive resin layer is formed in an upper layer on the drain electrodes 5b and the data lines 5a, and the common electrode 9a formed of a solid ITO film is formed in an upper layer on the insulating film 75. The insulating film 74 (first dielectric layer) formed of a silicon nitride film is formed in an upper layer on the common electrode 9a. The pixel electrodes 7a are formed in an island shape in an upper layer on the insulating film 74.

In the present embodiment as well, as in the case of the first embodiment, between the pixel electrodes 7a and the common electrode 9a, the common electrode 9a is formed as one electrode located on the lower layer side and each pixel electrode 7a is formed as the other electrode located on the upper layer side. Thus, in the present embodiment, the plurality of slits 7b for forming a fringe electric field are formed parallel to one another in each of the upper side pixel electrodes 7a.

Contact holes 75a are formed in the insulating film 75, and inside each of the contact holes 75a, a contact hole 74b is formed in the insulating film 74. Thus, each pixel electrode 7a is electrically connected to the drain electrode 5b through the contact hole 74b. In order to enable the above connection, the cutouts 9c are formed in the common electrode 9a.

In the thus configured liquid crystal device 100, a capacitance component C1 is formed at a portion at which the pixel electrode 7a overlaps the common electrode 9a via the insulating film 74 (first dielectric layer), while a capacitance component C2 is formed at a portion at which the common electrode 9a overlaps the extended portion 5c of the drain electrode 5b (light reflection layer) via the insulating film 75 (second dielectric layer). Furthermore, the capacitance component C1 and the capacitance component C2 are electrically connected in parallel with each other. Thus, the holding capacitor 60 is formed of a composite capacitance component of the capacitance components C1 and C2. Even when the capacitance component C1 is excessively small, the capacitance component C2 is able to compensate for the shortage of the capacitance value. In this way, the same advantageous effects as those of the first embodiment are obtained.

To manufacture the above configured liquid crystal device 100, in the manufacturing method described with reference to FIG. 4A to FIG. 4E regarding the first embodiment, it is only necessary that the drain electrodes 5b each having the extended portion 5c are patterned and then substantially the same processes as the lower layer insulating film forming process, the common electrode forming process, the upper layer insulating film forming process, and the pixel electrode forming process, which are described with reference to FIG. 4D and FIG. 4E, are performed. Thus, the light reflection layer forming process need not be separately performed. As a result, the number of manufacturing processes may be reduced to thereby make it possible to improve productivity.

Note that in the present embodiment, because the insulating film 75 is used as a dielectric layer, if the insulating film 75 is formed as a planarizing film using a photosensitive resin, the capacitance value of the capacitance component C2 will be excessively small. In this case, when liquid material that is formed by dissolving and dispersing polysilazane in a predetermined solvent is applied and then fired to form a silicon oxide film, the insulating film 7 may be formed as a planarizing film and hence it is possible to obtain a dielectric constant higher than that of a resin layer. That is, polysilazane is an inorganic polymer that only includes Si—H bond, N—H bond and Si—N bond. When liquid material in which polysilazane is dissolved and dispersed in a solvent made of xylene, mineral turpentine or high-boiling aromatic series solvent is applied and then fired under the temperature of about 350 to 500 degrees C. in the atmosphere or under the temperature of about 100 degrees C. in the water vapor atmosphere, it reacts with moisture and oxygen and is then inverted to a closely packed amorphous silicon oxide film.

### Third Embodiment

In the first embodiment or the second embodiment, between the pixel electrodes 7a and the common electrode 9a, the common electrode 9a is formed as one electrode located on the lower layer side and each pixel electrode 7a is formed as the other electrode located on the upper layer side. Instead, as in a third embodiment or a fourth embodiment described below, it is applicable that between the pixel electrodes 7a and the common electrode 9a, each pixel electrode 7a is formed as one electrode located on the lower layer side and the common electrode 9a is formed as the other electrode located on the upper layer side.

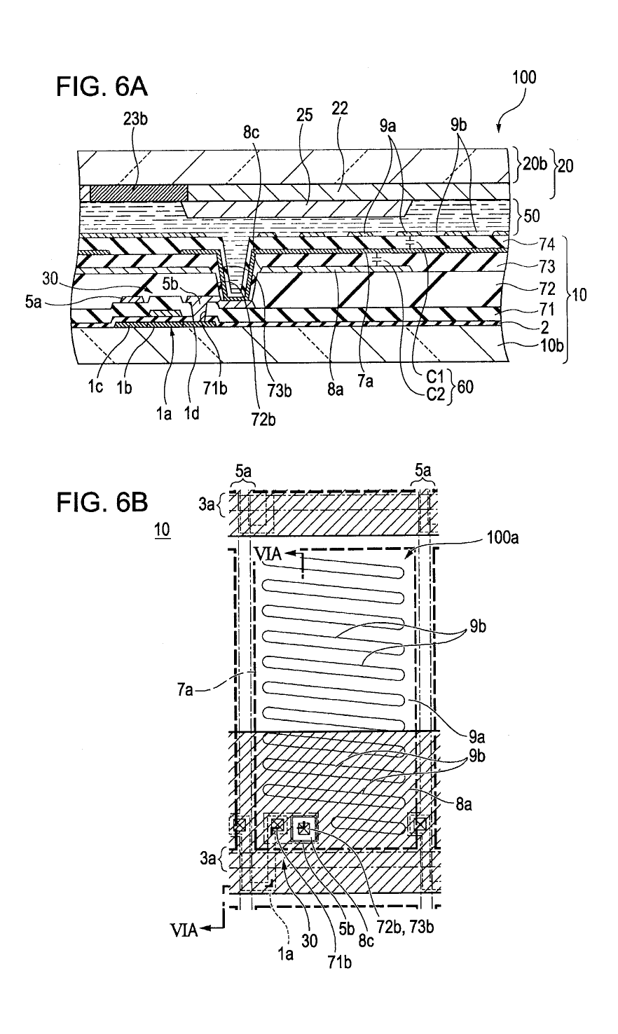

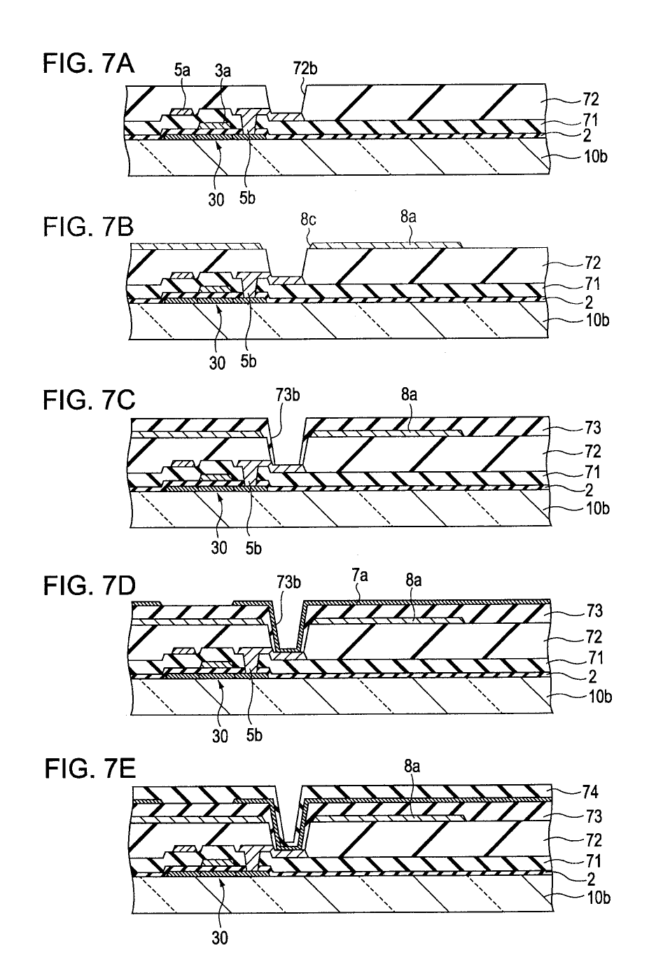

FIG. 6A is a cross-sectional view of a pixel of a liquid crystal device 100 according to the third embodiment of the invention. FIG. 6B is a plan view of mutually adjacent pixels in the element substrate 10. FIG. 6A corresponds to a cross-sectional view of the liquid crystal device 100, taken along the line VIA-VIA in FIG. 6B. FIG. 7A to FIG. 7E are cross-sectional views showing processes of a manufacturing method for the element substrate within a manufacturing process for the liquid crystal device according to the third embodiment of the invention. Note that the basic configuration of the present embodiment is the same as that of the first embodiment, so that the same reference numerals are assigned to the same or similar components, and a description thereof is omitted.

The liquid crystal device 100 shown in FIG. 6A and FIG. 6B is also a transflective liquid crystal device as in the case of the first embodiment. In the element substrate 10, the drain electrodes 5b formed in an upper layer on the interlayer insulating film 71 are electrically connected to the drain regions 1d of the thin film transistors 30 through the contact holes 71b formed in the interlayer insulating film 71. The interlayer insulating films 72, 73 and 74 are formed in the upper layer on the drain electrodes 5b.

The light reflection layers 8a, which are formed of an aluminum film, an aluminum alloy film, a silver film or a silver alloy film, are formed on the surface of the interlayer insulating film 72. In the present embodiment, the light reflection layers 8a are formed of a solid metal film that is formed in a band shape so as to extend over the plurality of pixels 100a arranged in the direction in which the scanning lines 3a extend.

The insulating film 73 (second dielectric layer) formed of a silicon nitride film is formed in the upper layer on the light reflection layers 8a, and the pixel electrodes 7a formed of a solid ITO film are formed in an island shape in the upper layer on the insulating film 73. In addition, the contact holes 72b are formed in the interlayer insulating film 72 and, inside each of the contact holes 72b, the contact hole 73b is formed in the insulating film 73. Thus, each pixel electrode 7a is electrically connected to the drain electrode 5b through the contact hole 73b. In order to enable the above connection, cutouts 8c are formed in the light reflection layers 8a.

The insulating film 74 (first dielectric layer) formed of a silicon nitride film is formed in the upper layer on the pixel electrodes 7a, and the common electrode 9a formed of an ITO film is formed in the upper layer on the insulating film 74 over substantially the entire surface of the image display area 10a shown in FIG. 2A. The common electrode 9a has slits 9b for forming a fringe electric field.

Here, each light reflection layer 8a is applied with the same electric potential as that of the common electrode 9a. The above configuration may be implemented, for example, by employing a configuration that the light reflection layers 8a are electrically connected to the common electrode 9a through contact holes (not shown) or a configuration that the same electric potential is applied to both of the light reflection layers 8a and the common electrode 9a.

In the thus configured liquid crystal device 100, a capacitance component C1 is formed at a portion at which the pixel electrode 7a overlaps the common electrode 9a via the insulating film 74 (first dielectric layer), while a capacitance component C2 is formed at a portion at which the pixel electrode 7a overlaps the light reflection layer 8a via the insulating film 73 (second dielectric layer). Furthermore, the capacitance component C1 and the capacitance component C2 are electrically connected in parallel with each other. Thus, in the present embodiment, as in the case of the first embodiment, the holding capacitor 60 is formed of a composite capacitance component of the capacitance components C1 and C2. Even when the capacitance component C1 is excessively small, the capacitance component C2 is able to compensate for the shortage of the capacitance value.

To manufacture the liquid crystal device 100 of the present embodiment, first, as shown in FIG. 7A, the thin film transistors 30, the scanning lines 3a, the interlayer insulating film 71, the data lines 5a, the drain electrodes 5b are formed in the same manner as that of the first embodiment, and a photosensitive resin is applied, exposed and developed to thereby form the interlayer insulating film 72 (planarizing film) having the contact holes 72b with a thickness of 1.5 to 2.0 μm.

Subsequently, in a light reflection layer forming process, a light reflective metal film formed of aluminum, aluminum alloy, silver or silver alloy is formed over the entire surface of the translucent substrate 10b, the metal film is patterned using a photolithography technology, and then, as shown in FIG. 7B, the light reflection layers 8a are formed in a band shape so as to extend over the plurality of pixels 100a. At this time, the cutouts 8c are formed in the light reflection layers 8a.

After that, in a lower layer insulating film forming process, as shown in FIG. 7C, using a CVD method or the like, the insulating film 73 formed of a silicon nitride film is formed, and then using a photolithography technology, the contact holes 73b are formed in the insulating film 73.

Next, in a pixel electrode forming process, as shown in FIG. 7D, a translucent conductive film formed of an ITO film is formed over the entire surface of the translucent substrate 10b, and the translucent conductive film is patterned using a photolithography technology to form the pixel electrodes 7a. As a result, each pixel electrode 7a is electrically connected to the drain electrode 5b through the contact hole 73b.

After that, in an upper layer insulating film forming process, as shown in FIG. 7E, using a CVD method or the like, the insulating film 74 formed of a silicon nitride film is formed.

Next, in a common electrode forming process, a translucent conductive film formed of an ITO film is formed over the entire surface of the translucent substrate 10b, and the translucent conductive film is patterned using a photolithography technology to form the common electrode 9a. At this time, the slits 9b are formed in the common electrode 9a.

### Fourth Embodiment

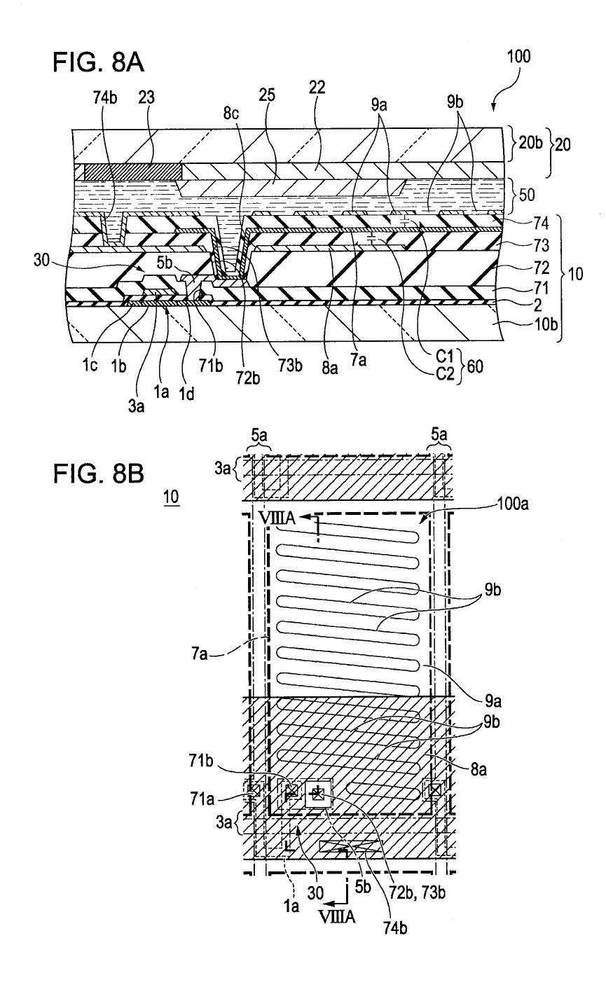

FIG. 8A is a cross-sectional view of a pixel of the liquid crystal device 100 according to a fourth embodiment of the invention. FIG. 8B is a plan view of mutually adjacent pixels in the element substrate 10. FIG. 8A corresponds to a cross-sectional view of the liquid crystal device 100, taken along the line VIIIA-VIIIA in FIG. 8B. Note that the basic configuration of the present embodiment is the same as that of the first embodiment and that of the third embodiment, so that the same reference numerals are assigned to the same or similar components, and a description thereof is omitted.

The liquid crystal device 100 shown in FIG. 8A and FIG. 8B is also a transflective liquid crystal device as in the case of the first embodiment and the third embodiment. In the element substrate 10, the drain electrodes 5b formed in an upper layer on the interlayer insulating film 71 are electrically connected to the drain regions 1d of the thin film transistors 30 through the contact holes 71b formed in the interlayer insulating film 71. The interlayer insulating films 72, 73 and 74 are formed in the upper layer on the drain electrodes 5b.

The light reflection layers 8a, which are formed of an aluminum film, an aluminum alloy film, a silver film or a silver alloy film, are formed on the surface of the interlayer insulating film 72. In the present embodiment, the light reflection layers 8a are formed of a solid metal film that is formed in a band shape so as to extend over the plurality of pixels 100a arranged in the direction in which the scanning lines 3a extend.

In the present embodiment, the pixel electrodes 7a formed of a solid ITO film are formed in an island shape on the surface of the insulating film 73 (second dielectric layer). In addition, the contact holes 72b are formed in the interlayer insulating film 72 and, inside each of the contact holes 72b, the contact hole 73b is formed in the insulating film 73. Thus, each pixel electrode 7a is electrically connected to the drain electrode 5b through the contact hole 73b. In addition, on the surface of the insulating film 74 (first dielectric layer), the common electrode 9a formed of an ITO film is formed substantially over the entire surface of the image display area 10a shown in FIG. 2A, and the slits 9b for forming a fringe electric field are formed in the common electrode 9a.

In the present embodiment, when the same electric potential is applied to both of the light reflection layers 8a and the common electrode 9a, the contact hole 74b is formed in the insulating films 73 and 74 in each of the plurality of pixels 100a, and the common electrode 9a is electrically connected to the light reflection layer 8a through the contact hole 74b in each of the plurality of pixels 100a. In the above configuration as well, a capacitance component C1 is formed at a portion at which the pixel electrode 7a overlaps the common electrode 9a via the insulating film 74, while a capacitance component C2 is formed at a portion at which the pixel electrode 7a overlaps the light reflection layer 8a via the insulating film 73. Thus, the holding capacitor 60 may be formed of a composite capacitance component of the capacitance components C1 and C2.

In addition, because the common electrode 9a is electrically connected to the light reflection layers 8a through the contact holes 74b at multiple portions, even when a resistance value is high due to the common electrode 9a being formed of a thin ITO film, the light reflection layers 8a function as an auxiliary wiring for the common electrode 9a. Thus, it is possible to obtain the similar advantageous effect to that the resistance value of the common electrode 9a is reduced and, hence, it is possible to improve the display quality.

To manufacture the above configured liquid crystal device 100, as shown in FIG. 7A, it is only necessary that the insulating film 74 is formed, the contact holes 74b are formed in the insulating films 73 and 74 and then the common electrode 9a is formed. Note that in the present embodiment, the configuration that the contact holes 74b successively extend through the insulating films 73 and 74 is employed. Instead, contact holes that are in communication with each other may be formed in the respective insulating films 73 and 74.

### Application Example of Reflective Liquid Crystal Device

In the above embodiments, the example in which the aspects of the invention are applied to the transflective liquid crystal device 100 is described. Instead, the aspects of the invention may be applied to a reflective liquid crystal device. That is, in the above embodiments, when the light reflection layers 8a are formed over all the regions in which the pixel electrode 7a overlaps the common electrode 9a in plan view in each of the plurality of pixels 100a, it is possible to form the reflective liquid crystal device 100 in any of the embodiments.

### Other Embodiments

In the above embodiments, a polysilicon film is used as the semiconductor layer 1a. Instead, the aspects of the invention may also be applied to the liquid crystal device 100 that uses an amorphous silicon film or a monocrystal silicon film as a semiconductor layer. Moreover, the aspects of the invention may also be applied to a liquid crystal device that uses a thin film diode element (nonlinear element) as a pixel switching element. Furthermore, in the above embodiments, the surface of each light reflection layer 8a is smooth. Instead, the aspects of the invention may also be applied to a liquid crystal device in which, when the liquid crystal device 100 is used as a direct-view-type display device, in order to prevent glare of the background due to reflection on the light reflection layers 8a, unevenness is formed in the lower layer side below the light reflection layers 8a and light scattering unevenness is formed on the surface of each light reflection layer 8.

### Examples of Application to Electronic Apparatus

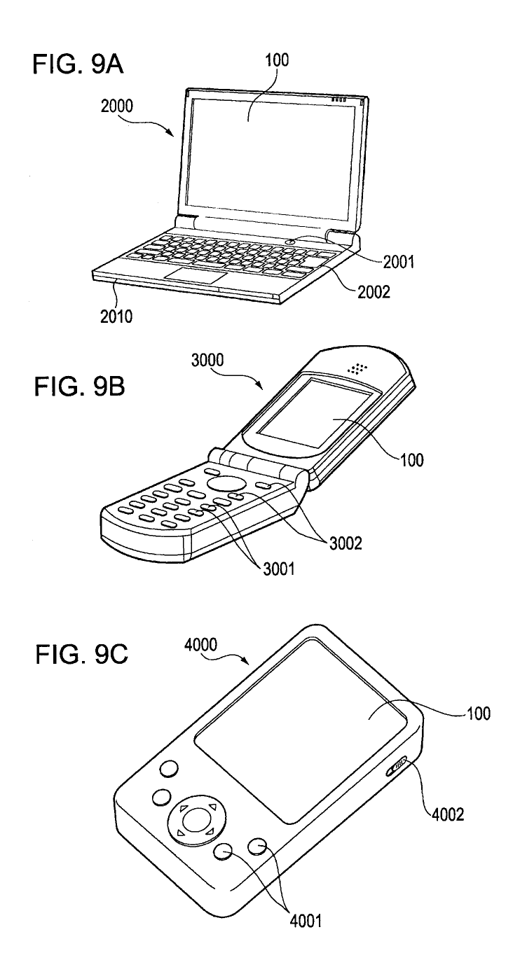

Electronic apparatuses to which the above described liquid crystal device 100 is applied will now be described. FIG. 9A is a view that shows a configuration of a mobile personal computer provided with the liquid crystal device 100. The personal computer 2000 includes the liquid crystal device 100, which serves as a display unit, and a main body portion 2010. The main body portion 2010 is provided with a power switch 2001 and a keyboard 2002. FIG. 9B is a view that shows a configuration of a cellular phone that is provided with the liquid crystal device 100. The mobile telephone 3000 includes a plurality of operation buttons 3001, a plurality of scroll buttons 3002, and the liquid crystal device 100, which serves as a display unit. By manipulating the scroll buttons 3002, an image displayed on the liquid crystal device 100 is scrolled. FIG. 9C is a view that shows a configuration of a personal digital assistants (PDA) that uses the liquid crystal device 100. The personal digital assistants 4000 includes a plurality of operation buttons 4001, a power switch 4002, and the liquid crystal device 100, which serves as a display unit. As the power switch 4002 is manipulated, various pieces of information, such as an address book and a schedule book, are displayed on the liquid crystal device 100.

Note that the electronic apparatuses that uses the liquid crystal device 100 include, in addition to the apparatuses shown in FIG. 9A to FIG. 9C, a digital still camera, a liquid crystal display television, a viewfinder-type or a direct-view-type video tape recorder, a car navigation system, a pager, a personal organizer, an electronic calculator, a word processor, a workstation, a video telephone, a point-of-sales terminal, and devices provided with a touch panel display. Then, as a display portion for these various electronic apparatuses, the above described liquid crystal device 100 may be applied.

What is claimed is:

1. A transflective or reflective liquid crystal device comprising:
a first substrate;
a second substrate arranged so as to face the first substrate;
a liquid crystal layer disposed between the first substrate and the second substrate;
a translucent pixel electrode that is electrically connected to a pixel switching element over the first substrate;
a common electrode that is formed so as to overlap the translucent pixel via a first dielectric layer in plan view;
a light reflection layer that is formed on the element substrate so as to overlap the pixel electrode and the common electrode in plan view in a lower layer below the pixel electrode and the common electrode, wherein,
the light reflection layer is formed so as to overlap one electrode which is either the pixel electrode or the common electrode located on a lower layer side via a second dielectric layer in plan view, and is applied with the same electric potential as that of the other electrode located on an upper layer side.

2. The liquid crystal device according to claim 1, wherein
the one electrode is the common electrode, wherein
the other electrode is the pixel electrode, and wherein
the light reflection layer is separately formed in each of the plurality of pixels.

3. The liquid crystal device according to claim 2, wherein
each light reflection layer is electrically connected to the pixel switching element, and wherein
each pixel electrode is electrically connected to the pixel switching element through the light reflection layer.

4. The liquid crystal device according to claim 1, wherein
the one electrode is the pixel electrode, and wherein
the other electrode is the common electrode.

5. The liquid crystal device according to claim 4, wherein
each light reflection layer is formed to extend over the plurality of pixels, and wherein
the common electrode is connected to the light reflection layer at multiple portions.

6. The liquid crystal device according to claim 5, wherein each light reflection layer extends in a band shape over the plurality of pixels.

7. An electronic apparatus comprising the liquid crystal device according to claim 1.
